(19) United States
(12) Patent Application Publication
(10) Pub. No.: US 2026/0114468 A1
(43) Pub. Date: Apr. 30, 2026

(54) PACKAGED FOOD MIXTURE

(71) Applicant: CPRG, LLC, Newark, DE (US)

(72) Inventor: Christopher John CARDAMONE, Newark, DE (US)

(73) Assignee: CPRG, LLC, Newark, DE (US)

(21) Appl. No.: 19/371,780

(22) Filed: Oct. 28, 2025

Related U.S. Application Data
(60) Provisional application No. 63/713,428, filed on Oct. 29, 2024.
(60) Provisional application No. 63/899,015, filed on Oct. 14, 2025.

(51) Int. Cl. A23G 3/34; A23G 3/38; A23G 3/46; A23G 3/48

(52) U.S. Cl. CPC A23G 3/346; A23G 3/0019; A23G 3/38; A23G 3/46; A23G 3/48

(57) ABSTRACT

The present invention provides a powdered mixture comprising a non-dairy whipped topping, an isolated protein powder, and a plant-based sweetener that does not affect blood sugar or insulin levels. Importantly, the confection can easily be made at home using only water to reconstitute the powdered ingredients and comes in a variety of flavors. The confections disclosed herein can be configured in a solid form, a powdered form, a frozen confection, or as a semisolid or frozen beverage.

### RELATED APPLICATIONS

This application claims priority under 35 U.S.C. § 119(e) to U.S. Provisional Patent Application No. 63/713,428, filed Oct. 29, 2024, and U.S. Provisional Patent Application No. 63/899,015, filed Oct. 14, 2025, which applications are incorporated herein by reference.

### FIELD OF INVENTION

The present invention relates to confections, including frozen confections that are protein enhanced and dairy free and are reconstituted by adding only water to the powdered product and mixing and include ice cream, popsicles, frozen drinks, and gelatos these-products are protein enhanced and are supplement enhanced.

### BACKGROUND OF THE INVENTION

Frozen confections, such as ice creams, sorbets and the like have been around for a long time and are popular foodstuffs. Fat is an important constituent of some such confections providing a creamy texture but with good mouth feel but also comprising significant amounts of sugar. However, recent trends in fitness awareness have made confections, such as ice cream, less attractive for those seeking healthy lifestyles. The health food industry has filled the void with a variety of different healthy alternatives ranging from nutrition bars to protein shakes, to non-dairy toppings. In addition, those with busy lifestyles need something that can be made at home, have a long shelf life and actually taste good.

Unfortunately, some current health food options, while providing healthy alternatives, lack the taste or texture that are appealing to the consumer. For example, protein shakes and powders tend to have a gritty or grainy taste. Sugar substitutes may seem overly sweet or bitter. Thus, while these options have identified a large market few have provided an easy, good tasting and healthy alternative to ice cream.

Health-conscious consumers are now looking for frozen confections which have all the properties of these traditional products but are healthier. Attempts have therefore been made to produce frozen confections which are lower in fats. However, it has not been possible simply to reduce the fats in ice cream, which contains both saturated and unsaturated fats, because it leads to icy or granular products with less-than-ideal mouth feel. There is a need therefore to provide frozen confections containing high levels of proteins and less fat which also have a low glycemic index for those seeking a healthy lifestyle.

### SUMMARY

In light of the increased desire for healthy/healthier products in the confectionary world, the present invention provides a powdered mixture comprising non-dairy, protein enhanced, confections with an artificial sweetener that does not affect blood sugar or insulin level and reduced fat compared to premium ice cream. Importantly, the confection can easily be made at home be using only water to provide an aqueous mixture which can be whipped and comes in a variety of flavors. The confections disclosed herein can come in a powdered form and can be configured as a frozen confection, or a semisolid or a frozen beverage or a spread.

In various exemplary embodiments, disclosed herein is a powdered mix for making a confection comprising: a vegetable based powdered whipped topping; a protein powder isolate; a plant-based sugar alternative; and one or more flavorings; wherein the powdered mix is dairy free and lactose free; wherein when reconstituted with water, juice, milk substitute or the like, the mixture comprises an aqueous mixture.

In various embodiments, the plant-based powdered whipped topping comprises coconut cream, aquafaba, soy milk, almond milk, coconut oil, palm oil, palm kernel oil or a combination thereof. In some embodiments, the protein is whey or soy protein. In various embodiments, the plant-based sugar alternative is selected from stevia, monk fruit, allulose, coconut sugar, maple syrup, agave nectar, honey, erythritol, xylitol, sucralose, neotame or a combination thereof. In some embodiments, the flavoring is selected from chocolate, vanilla, strawberry, coffee, vanilla, cocoa, peanut butter, strawberry, blueberry, banana, peach, pineapple, orange, lemon, caramel, pistachio, coconut, coffee, cinnamon, mint, powdered matcha, mint, mocha, mango, hazelnut, kiwi, watermelon, taro, black truffle, white truffle and mixtures thereof. In some embodiments the mix further comprises salt.

In these embodiments, the powdered mix has a shelf life of two years or more. In various embodiments the powdered mix further comprises an emulsifier. In these embodiments, the emulsifier is selected from guar gum, xanthan gum, lecithin, polysorbates, monoglycerides, diglycerides, stearyl alcohol, carrageenan, gum Arabic, polysorbate, and combinations thereof. In some embodiments, the fat, carbohydrate and protein are present in a ratio of about 10% to 75%/25% to 80%/5% to 40%. In various embodiments, the plant-based sugar alternative comprises 5% to 60% of total carbohydrate component. In some embodiments, the mix is free of polyunsaturated fats. In various embodiments the aqueous mixture is served room temperature, chilled, or frozen.

In still other exemplary embodiments disclosed is an aqueous confection comprising: a vegetable based powdered whipped topping; a protein powder isolate; a plant-based sugar alternative; a flavoring; and water; wherein the aqueous confection is dairy free and lactose free.

In yet other exemplary embodiments disclosed is an aqueous confection comprising: a vegetable based powdered whipped topping; a powder protein isolate; a plant-based sugar alternative; a flavoring; and water; wherein the aqueous confection is dairy free and lactose free. In various embodiments, the aqueous confection served at room temperature, chilled or frozen. In some embodiments, the protein isolate is whey protein, soy protein and the like. In some embodiments, the plant-based sugar alternative is selected from stevia, monk fruit, allulose, coconut sugar, maple syrup, agave nectar, honey, erythritol, xylitol, sucralose, and neotame.

In various embodiments, the flavoring is selected from chocolate, vanilla, strawberry, coffee, vanilla, cocoa, peanut butter, strawberry, blueberry, banana, peach, pineapple, orange, lemon, caramel, pistachio, coconut, coffee, cinnamon, mint, matcha, mocha, mango, hazelnut, kiwi, watermelon, taro, black truffle, white truffle and mixtures thereof. In some embodiments, the fat, carbohydrate and protein are present in a ratio, in g % of about 10-75/25-80/5-40. In some exemplary embodiments, the plant-based sugar alternative comprises 20-60% of total carbohydrate component.

In still other exemplary embodiments, disclosed is a method of making a confection comprising: (a) combining: a vegetable based powdered whipped topping; a protein powder isolate; a plant-based sugar alternative; and a flavoring; to form a mixture; (b) sifting the mixture through a 15-50 gauge mesh sieve to create sifted mixture comprising a fine powder; and (c) mixing the sifted mixture with water to provide an aqueous mixture; wherein the confection is dairy free.

In various embodiments, the sifted mixture is passed through the 30-gauge mesh a second time. In these exemplary embodiments, the confection is served at room temperature, chilled or frozen. In various embodiments, the vegetable based powdered whipped topping is made from coconut cream, aquafaba, soy milk, almond milk, hydrogenated coconut oil, hydrogenated palm oil and combinations thereof. In some embodiments, the protein powder isolate is soy protein, whey protein or the like. In various embodiments, the plant-based sugar alternative is selected from stevia, monk fruit, allulose, coconut sugar, maple syrup, agave nectar, honey, erythritol, xylitol, sucralose, and neotame. In embodiments, the flavoring is selected from chocolate, vanilla, strawberry, vanilla, cocoa, peanut butter, strawberry, blueberry, banana, peach, pineapple, orange, lemon, caramel, pistachio, coconut, coffee, cinnamon, matcha, mint, mocha, mango, hazelnut, kiwi, watermelon, taro, black truffle, white truffle and mixtures thereof. In these embodiments the fat, carbohydrate and protein are present in a ratio in g/% of about 10-75/20-80/5-40. In embodiments, the plant-based sugar alternative comprises 20-60% of total carbohydrate component.

The present invention in yet another embodiment provides a kit comprising the mixture of any one of the aspects or embodiments of the present invention or the dessert mixture of any of the aspects of the present invention packaged with directions for use.

Yet another embodiment provides a kit comprising a first packaging unit comprising a second packaging unit and optionally instructions for preparing the dessert mixture, and a second packaging unit comprising the mixture or any one of the aspects of the present invention or the dessert mixture of any of the aspects of the present invention.

### BRIEF DESCRIPTION OF THE DRAWINGS

The following drawings form part of the specification and are included to further demonstrate certain embodiments or various aspects of the invention. In some instances, embodiments of the invention can be best understood by referring to the accompanying drawings in combination with the detailed description presented herein. The description and accompanying drawings may highlight a certain specific example, or a certain aspect of the invention. However, one skilled in the art will understand that portions of the example or aspect may be used in combination with other examples or aspects of the invention.

FIG. 1, Illustrates the ingredients used in a frozen vanilla confection.

FIG. 2, Illustrates a first step in making the mixture, combining the ingredients.

FIG. 3, Combining the ingredients, a second step in making the mixture.

FIG. 4, Sifting the combined ingredients a first time, a third step in making the mixture.

FIG. 5, Sifting the ingredients a second time, a fourth step in making the mixture.

FIG. 6, The final powdered product.

FIG. 7, Nutritional label for the vanilla product.

FIG. 8, Nutritional label for the strawberry product.

FIG. 9, Nutritional label for the chocolate product.

### DETAILED DESCRIPTION OF THE INVENTION

Because of the increasing demand for healthier, protein enhanced products in the confectionary category, the present invention provides a powdered mixture comprising a non dairy whipped topping, an isolated protein powder, and a plant-based sweetener that does not affect blood sugar or insulin levels. The confection can easily be made at home using only water to reconstitute the powdered ingredients and comes in a variety of flavors. The confections disclosed herein can be configured in a solid form, a powdered form, a frozen confection, or a semisolid or a frozen beverage.

The following definitions are included to provide a clear and consistent understanding of the specification and claims. As used herein, the recited terms have the following meanings. All other terms and phrases used in this specification have their ordinary meanings as one of skill in the art would understand.

References in the specification to “one embodiment”, “an embodiment”, etc., indicate that the embodiment described may include a particular aspect, feature, structure, moiety, or characteristic, but not every embodiment necessarily includes that aspect, feature, structure, moiety, or characteristic. Moreover, such phrases may, but do not necessarily, refer to the same embodiment referred to in other portions of the specification. Further, when a particular aspect, feature, structure, moiety, or characteristic is described in connection with an embodiment, it is within the knowledge of one skilled in the art to affect or connect such aspect, feature, structure, moiety, or characteristic with other embodiments, whether or not explicitly described.

The singular forms “a,” “an,” and “the” include plural reference unless the context clearly dictates otherwise. Thus, for example, a reference to “a compound” includes a plurality of such compounds, so that a compound X includes a plurality of compounds X. It is further noted that the claims may be drafted to exclude any optional element. As such, this statement is intended to serve as antecedent basis for the use of exclusive terminology, such as “solely,” “only,” and the like, in connection with any element described herein, and/or the recitation of claim elements or use of “negative” limitations.

The term “and/or” means any one of the items, any combination of the items, or all of the items with which this term is associated. The phrases “one or more” and “at least one” are readily understood by one of skill in the art, particularly when read in context of its usage. For example, the phrase can mean one, two, three, four, five, six, ten, 100, or any upper limit approximately 10, 100, or 1000 times higher than a recited lower limit. For example, one or more substituents on a phenyl ring refers to one to five substituents on the ring.

As will be understood by the skilled artisan, all numbers, including those expressing quantities of ingredients, properties such as molecular weight, reaction conditions, and so forth, are approximations and are understood as being optionally modified in all instances by the term “about.” These values can vary depending upon the desired properties sought to be obtained by those skilled in the art utilizing the teachings of the descriptions herein. It is also understood that such values inherently contain variability necessarily resulting from the standard deviations found in their respective testing measurements. When values are expressed as approximations, by use of the antecedent “about,” it will be understood that the particular value without the modifier “about” also forms a further aspect.

The terms “about” and “approximately” are used interchangeably. Both terms can refer to a variation of ±5%, ±10%, ±20%, or ±25% of the value specified. For example, “about 50” percent can in some embodiments carry a variation from 45 to 55 percent, or as otherwise defined by a particular claim. For integer ranges, the term “about” can include one or two integers greater than and/or less than a recited integer at each end of the range. Unless indicated otherwise herein, the terms “about” and “approximately” are intended to include values, e.g., weight percentages, proximate to the recited range that are equivalent in terms of the functionality of the individual ingredient, composition, or embodiment. The terms “about” and “approximately” can also modify the endpoints of a recited range as discussed above in this paragraph.

As will be understood by one skilled in the art, for any and all purposes, particularly in terms of providing a written description, all ranges recited herein also encompass any and all possible sub-ranges and combinations of sub-ranges thereof, as well as the individual values making up the range, particularly integer values. It is therefore understood that each unit between two particular units is also disclosed. For example, if 10 to 15 is disclosed, then 11, 12, 13, and 14 are also disclosed, individually, and as part of a range. A recited range (e.g., weight percentages or carbon groups) includes each specific value, integer, decimal, or identity within the range. Any listed range can be easily recognized as sufficiently describing and enabling the same range being broken down into at least equal halves, thirds, quarters, fifths, or tenths. As a non-limiting example, each range discussed herein can be readily broken down into a lower third, middle third and upper third, etc. As will also be understood by one skilled in the art, all language such as “up to”, “at least”, “greater than”, “less than”, “more than”, “or more”, and the like, include the number recited and such terms refer to ranges that can be subsequently broken down into sub-ranges as discussed above. In the same manner, all ratios recited herein also include all sub-ratios falling within the broader ratio. Accordingly, specific values recited for radicals, substituents, and ranges, are for illustration only; they do not exclude other defined values or other values within defined ranges for radicals and substituents. It will be further understood that the endpoints of each of the ranges are significant both in relation to the other endpoint, and independently of the other endpoint.

This disclosure provides ranges, limits, and deviations to variables such as volume, mass, percentages, ratios, etc. It is understood by an ordinary person skilled in the art that a range, such as “number 1” to “number 2”, implies a continuous range of numbers that includes the whole numbers and fractional numbers. For example, 1 to 10 means 1, 2, 3, 4, 5, . . . 9, 10. It also means 1.0, 1.1, 1.2. 1.3, . . . , 9.8, 9.9, 10.0, and also means 1.01, 1.02, 1.03, and so on. If the variable disclosed is a number less than “number 10”, it implies a continuous range that includes whole numbers and fractional numbers less than number 10, as discussed above. Similarly, if the variable disclosed is a number greater than “number 10”, it implies a continuous range that includes whole numbers and fractional numbers greater than number 10. These ranges can be modified by the term “about”, whose meaning has been described above.

One skilled in the art will also readily recognize that where members are grouped together in a common manner, such as in a Markush group, the invention encompasses not only the entire group listed as a whole, but each member of the group individually and all possible subgroups of the main group. Additionally, for all purposes, the invention encompasses not only the main group, but also the main group absent one or more of the group members. The invention therefore envisages the explicit exclusion of any one or more of members of a recited group. Accordingly, provisos may apply to any of the disclosed categories or embodiments whereby any one or more of the recited elements, species, or embodiments, may be excluded from such categories or embodiments, for example, for use in an explicit negative limitation.

The term “substantially” as used herein, is a broad term and is used in its ordinary sense, including, without limitation, being largely but not necessarily wholly that which is specified. For example, the term could refer to a numerical value that may not be 100% the full numerical value. The full numerical value may be less by about 1%, about 2%, about 3%, about 4%, about 5%, about 6%, about 7%, about 8%, about 9%, about 10%, about 15%, or about 20%.

Wherever the term “comprising” is used herein, options are contemplated wherein the terms “consisting of” or “consisting essentially of” are used instead. As used herein, “comprising” is synonymous with “including,” “containing,” or “characterized by,” and is inclusive or open-ended and does not exclude additional, unrecited elements or method steps. As used herein, “consisting of” excludes any element, step, or ingredient not specified in the aspect element. As used herein, “consisting essentially of” does not exclude materials or steps that do not materially affect the basic and novel characteristics of the aspect. In each instance herein any of the terms “comprising”, “consisting essentially of” and “consisting of” may be replaced with either of the other two terms. The disclosure illustratively described herein may be suitably practiced in the absence of any element or elements, limitation, or limitations not specifically disclosed herein.

The term “glycemic index (GI) refers to a measure of how quickly a carbohydrate-containing food raises blood sugar levels compared to glucose, which has a GI of 100. Carbohydrates that do not raise blood sugar levels have a GI of 0 and are said to be calorie free.

The term “artificial sweeteners” as used herein is intended to represent ingredients which are synthetic non-caloric sweeteners characterized by a strong sweetening flavor without calories. They are mainly found in soft drinks, snack foods, sugar-free candies, and dairy products. The term “artificial sweetener” can also refer to a substance that has been chemically made to mimic sugar. The more illustrative examples including sugar substitutes fall into this category: aspartame, saccharin and sucralose, stevia and allulose. These are zero calorie sweeteners and do have a zero glycemic index. Artificial sweeteners are found in many “sugar free” products like soda.

Allulose offers a natural, low-calorie alternative to sugar, mimicking its taste and behavior in baking without the bitter aftertaste of some other sweeteners like stevia or monk fruit. Unlike sugar alcohols like erythritol or xylitol, it is not absorbed by the gut microbiota and is unlikely to cause digestive discomfort. Allulose is found naturally in small amounts in foods such as brown sugar, maple syrup, molasses, wheat, and dried fruits like figs and raisins. Other natural sources include jackfruit.

The term “collagen” as used herein is intended to mean a flavorless supplement made from animal collagen that's broken down into a powder form. It's often added to foods and drinks like smoothies, coffee, and protein bars. Collagen powder can be purchased from many commercial sources and online retailers.

The term “BPC-157” refers to “Body Protection Compound-157”. BPC-157 is a fifteen amino acid long oligopeptide that may have cytoprotective, neuroprotective, and anti-inflammatory effects, and may also accelerate tissue and organ healing.

The term “configured” as used herein is intended to mean arranging a material in a particular or put together in a particular form or configuration. Illustrative example is wherein different ingredients are mixed together to form a new formulation/combination.

The term “dessert” as used herein is intended to mean a usually sweet course or dish (as of pastry or ice cream) usually served at the end of a meal.

The term “electrolyte” as used herein is intended to represent substances that have a natural positive or negative electrical charge when dissolved in water. They help the body regulate chemical reactions, maintain the balance between fluids inside and outside your cells. Illustrative examples of electrolytes are magnesium, calcium, chloride, phosphate, potassium, and sodium chloride.

The terms “emulsifying agent” or “emulsifier” or “emulsifiers” as used herein are a chemical additive that helps two liquids mix. Additional information is described in “Ice Cream”, 6^{th} Edition, pages 85-86. The terms “emulsifying agent” or “emulsifiers” or “emulsifier” as used herein also includes mono- and di-glycerides of saturated or unsaturated fatty acids (e.g. monoglyceryl palmitate—MGP), polyoxyethylene derivatives of hexahydric alcohols (usually sorbitol), glycols, glycol esters, polyglycerol esters, sorbitan esters, stearoyl lactylate, acetic acid esters, lactic acid esters, citric acid esters, acetylated monoglyceride, diacetyl tartaric acid esters, polyoxyethylene sorbitan esters (such as polysorbate 80), sucrose esters, lecithin, egg, egg yolk and surface active proteins and protein derivatives (other than milk protein), guar gum and gum arabic, The term also includes mixtures of any the above. However, the term “emulsifier” as used herein does not include milk proteins. As pointed out above, fats and oils may include small amounts of substances such as mono or diglycerides or phospholipids. The term “emulsifier” does not include such molecules when they are naturally present in the fat in small quantities.

The term “frozen confection” as used in this specification means a sweet-tasting fabricated foodstuff intended for consumption in the frozen state (i.e., under conditions wherein the temperature of the foodstuff is less than 0° C. Frozen confections are made by freezing a pasteurized mix of ingredients. Such frozen confections include ice cream, frozen drinks and popsicles. Those of skill in the art will appreciate that some confections are not frozen. For example, mousses and puddings which may be consumed chilled or room temperature as a spread.

As used herein, the term “spread” refers to a soft, spreadable food like jam or peanut butter that is applied to another food, such as bread.

The terms “flavoring agent” or “flavoring” are used herein interchangeably is intended to mean agents or substances added to food(s) or drinks to enhance or modify their taste, aroma, or texture. These agents can be natural or artificial and come in various forms such as liquids, powders, or extracts. There are several types of flavoring agents, including natural flavoring agents which are derived from natural sources such as plants, fruits, and vegetables. Illustrative examples include vanilla, cocoa, peanut butter, strawberry, blueberry, banana, peach, pineapple, orange, lemon, caramel, pistachio, coconut, coffee, cinnamon, mint, powdered matcha, mint, mocha, mango, hazelnut, kiwi, watermelon, taro, black truffle, white truffle and mixtures thereof. Of course, those of skill in the art will appreciate that a variety of synthetic flavorings are available as well.

The term “frozen beverage” as used herein is intended to mean beverages/drinks that are made by blending alcoholic or non-alcoholic ingredients to create a slushy texture. Illustrative examples include frozen margarita, frozen soda, slushy drinks, blended coffee or crème drinks.

The term “mouthfeel” refers to a subjective feeling an individual has when eating a substance. A good mouthfeel means the consumer finds the texture of a food pleasing and as expected for a particular food.

The term “fat” or “fat component” as used herein is intended to represent fats that are largely made up of triglycerides (approximately 98%), together with minor amounts of other components such as phospholipids and diglycerides. Fat in food is a fatty acid ester or mixture of esters, which are a major source of energy in the human diet. Fats are a key component of many foods. Triglycerides are esters of glycerol with three fatty acids. Fatty acids which have no carbon-carbon double bonds are said to be saturated (herein abbreviated as SAFA), whereas fatty acids that contain one or more carbon-carbon double bonds are said to be monounsaturated (abbreviated as MUFA) and polyunsaturated (PUFA) respectively. Fats that are liquid at ambient temperatures are often referred to as oils. In some instances, vegetable oils containing saturated fats, which are solid at room temperature can be blended and whipped to provide a smooth textured product which can be eaten at room temperature, chilled or frozen. Those of skill int the art will appreciate that confection made with saturated fats will be solid at room temperature and maintain their integrity.

The term “frozen confection” as used herein is intended to mean a dessert made by freezing liquids, semi-solids, and sometimes solids. They may be based on flavored water (examples include shave ice, ice pops, sorbet, snow cones), or fruit purées (such as sorbet), or milk and cream (examples include most ice creams, sundae, sherbet), or custard (frozen custard and some ice creams), or mousse (semifreddo), and others.

The term “frozen shake” as used herein is intended to mean a sweet, thick, cold beverage made by blending milk, ice cream, and flavorings. A cold milkshake is also sometimes referred to a frozen shake.

The term “hydration/hydrating agent” as used herein is intended to mean a substance that provides hydration to the body. Hydration agents are in liquid form and illustrative examples include water, milk, water fortified with vitamins, electrolytes and the like.

The term “gum arabic” as used herein is intended to represent a substance used in the food industry as a stabilizer, emulsifying agent, and thickening agent in icings, fillings, soft candy, chewing gum, and other confectionery, and to bind the sweeteners and flavorings in soft drinks. A solution of sugar and gum arabic in water, gomme syrup, is sometimes used in cocktails to prevent the sugar from crystallizing and provide a smooth texture.

The term “low-calorie sweeteners” (LCS) as used herein is intended to mean sweeteners that contain few to no calories but have a higher intensity of sweetness per gram than sweeteners with calories, such as, table sugar, fruit juice concentrates, and corn syrups. Other names for LCS are non-nutritive sweeteners, artificial sweeteners, sugar substitutes, and high-intensity sweeteners. Illustrative examples of low-calorie sweeteners include saccharin, sucralose, allulose, and the like.

The term “milk proteins” as used herein in intended to represent sources of milk protein including milk, concentrated milk, milk powders (such as skimmed milk powder), caseins, caseinates (such as sodium and/or calcium caseinates) whey, whey powders and whey protein concentrates isolates. Sources of milk protein generally also comprise other materials. For example, skimmed milk powder typically comprises 37% milk protein, 55% lactose and 8% milk minerals. As used herein, the term “whey proteins” refers to protein that is a natural byproduct of cheese-making. After enzymes are added to milk, the milk separates into solid curds (used for cheese) and a liquid portion called whey. “Isolated” protein a highly purified, processed form of protein, typically a powder, where most of the fat, carbohydrates, and lactose have been removed, resulting in a product that is 90% protein or more. It can be made from various sources, such as milk (whey), peas, or soy, and is a popular choice for athletes and individuals with sensitive digestive systems or lactose intolerance. It is a high-quality, complete protein, meaning it contains all nine essential amino acids. Typically, isolated whey protein has no detectable lactose component.

The term “minor amount” is intended to mean the ingredient that is present in a minor amount is less than about 0.25% by weight of the total mixture. A preferred range for an ingredient present in a minor amount is from about 0.25% to about 10%, and a particularly preferred range is from about 0.25% to about 10% by weight of the mixture.

The term “mixture” as defined herein refers to a combination of two or more individual components, in varying proportions, that may or may not retail their respective properties or may impart their properties to the entire mixture. A mixture can also be a physical blend of two or more substances that preserve their identities and are blended in the form of solids, solutions, suspensions, or colloids. A mixture can be heterogenous or homogenous. Illustrative examples include sugar and water, salt and water, soft drink water, lemonade, ice-cream, slurpy, frozen beverage, and air which are all examples of homogeneous mixtures. Illustrative examples of heterogenous mixtures include garlic salt, soil and sand, oil and water, bird feed i.e. a mixture of various grains, and the like. As used herein, the term “powdered mix” or “powdered mixture” refers to a granular mixture of various powdered components which are sifted together and mixed to homogeneity.

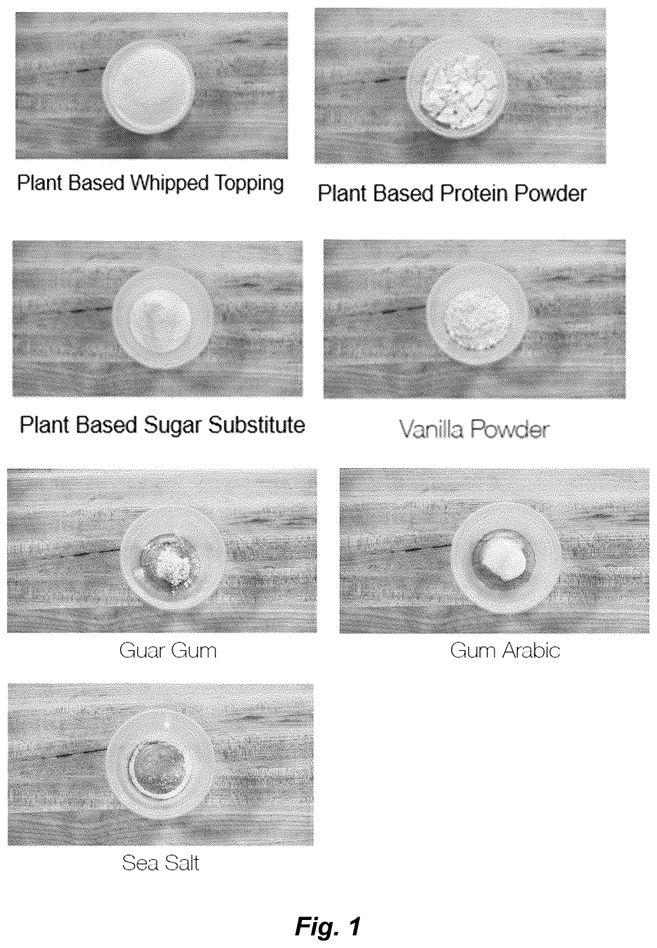

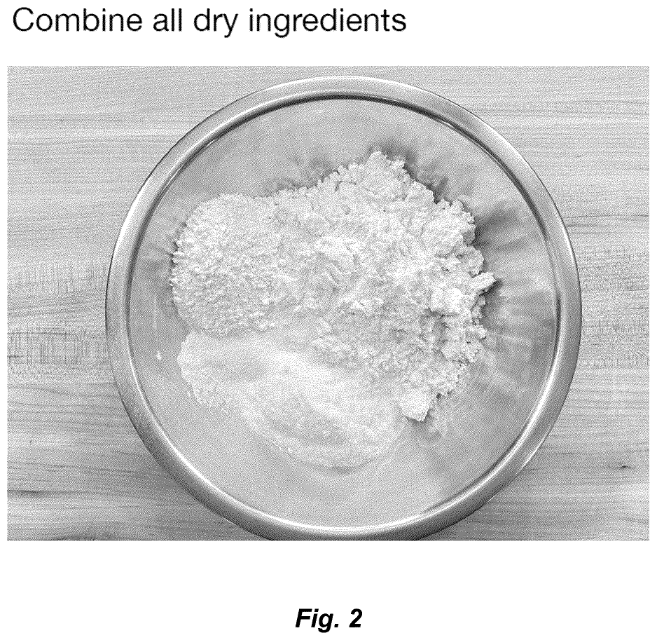

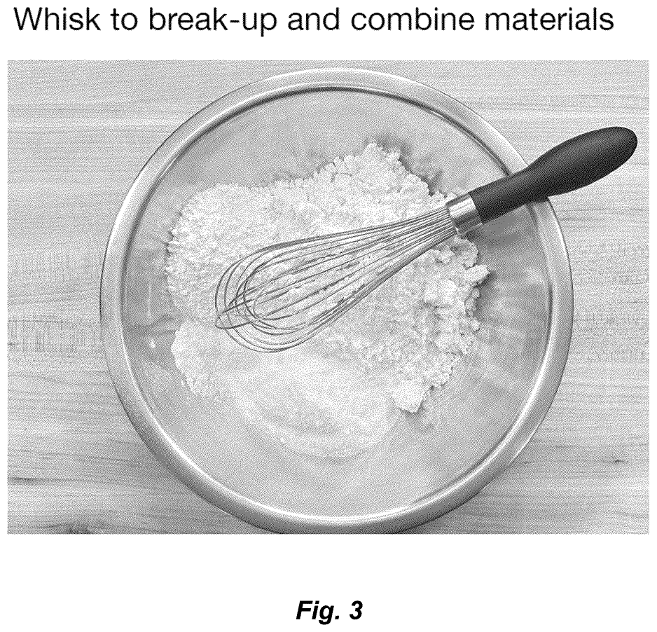

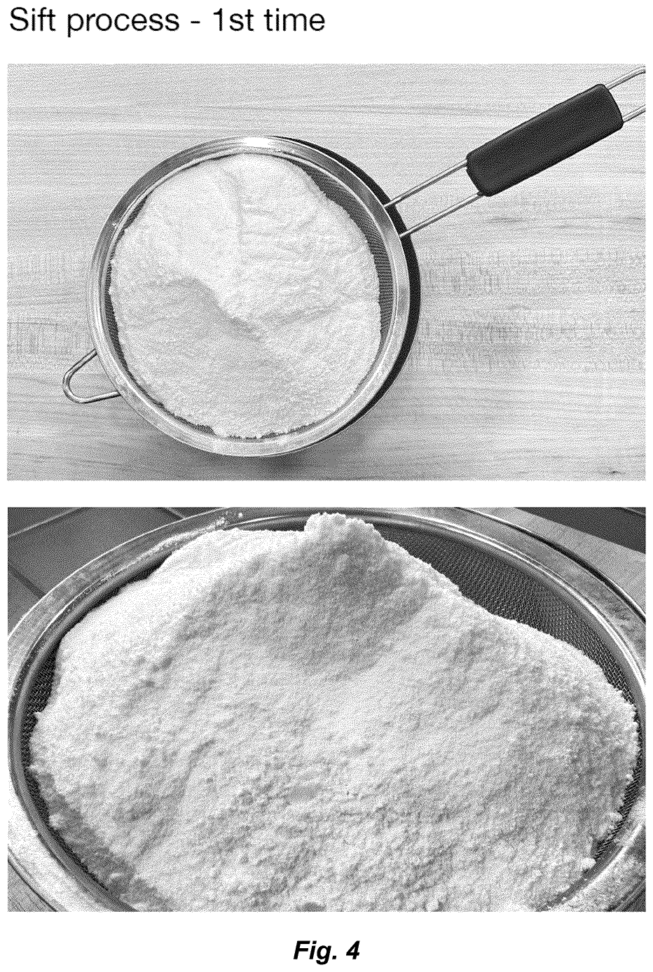

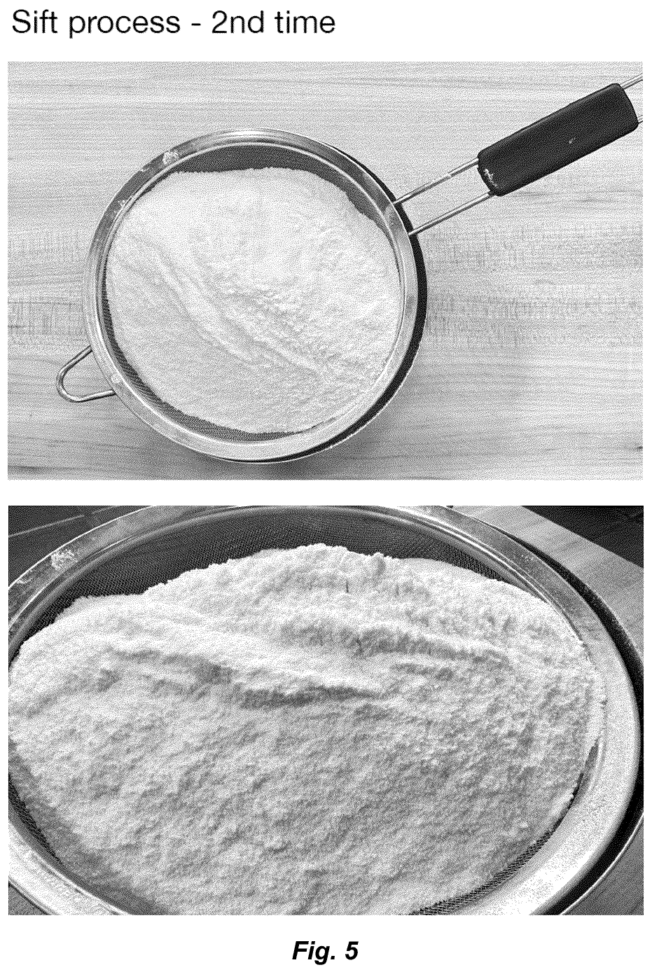

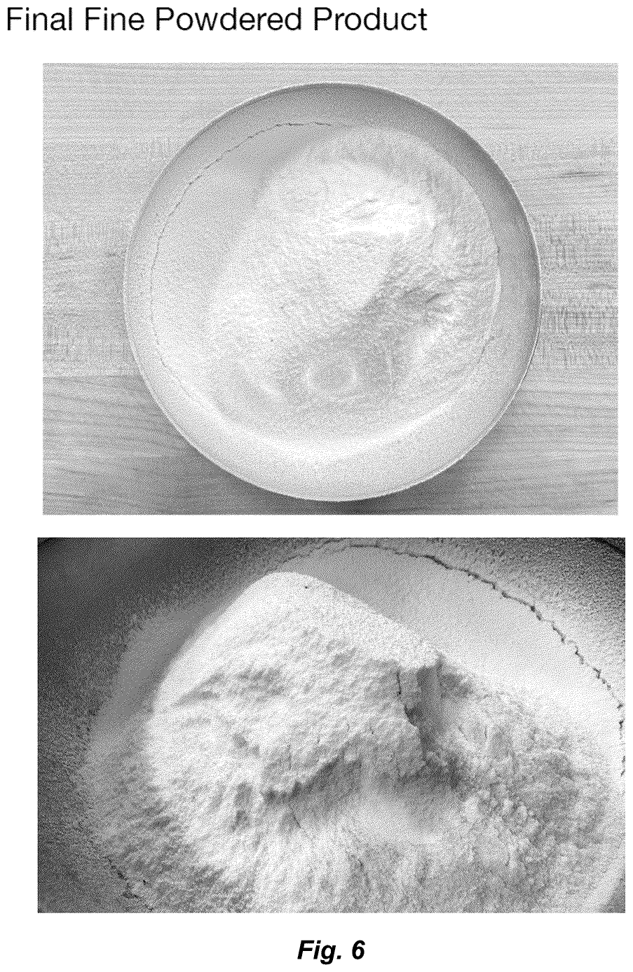

In various embodiments powdered plant-based whipped topping, plant-based protein powder, plant-based sugar substitute, flavoring an emulsifier and thickener (guar gum), a binder (gum arabic), and a seasoning agent (salt) FIG. 1, are combined together, FIG. 2. In these embodiments, the components are whisked together to break-up and further combined together FIG. 3. The whisked components are then sifted through a fine mesh ranging from 15- to 50-gauge, FIG. 4. To reduce the mix to a fine powdered product they may may be sifted again through the mesh (FIGS. 5 and 6). In many embodiments, the powdered components are water soluble.

In instances, the powdered mix has non-water-soluble components such as nuts, coconut meat or chips (such as chocolate) that are not water soluble. The term “aqueous mixture” refers to a powdered mixture that has water added to it wherein the water-soluble components dissolve into a homogenous, smooth texture. Those of skill in the art will appreciate that the viscosity of the aqueous mixture will depend on the amount of water added and the amount of aeration in the aqueous mixture during the to reconstitute it into its hydrated components. As used herein the term “reconstituted” refers to a dehydrated foodstuff that is rehydrated by water.

The term “moderate amount” means an amount that is less than about 50% by weight of the total mixture. A preferred range for an ingredient present in a moderate amount is from about 8% to about 30%, and a particularly preferred range is from about 8% to about 30% by weight of the mixture.

The term “nutritional benefits” represents positive effects on the body of consuming foods or substances that provide the nutrients the body needs to function properly. Nutritional benefits include building strong bones, maintaining healthy blood sugar levels, improving muscle strength, preventing diseases, and the like.

The term “powdered form” represents material that is a solid but free flowing and is devoid of moisture. A material in a powdered form can be obtained by grinding material in a solid state. Illustrative examples of powder form are salt, ground black pepper, powdered sugar, and the like.

The term “supplement” refers to nutritional products, taken orally, that contain vitamins, minerals, herbs, amino acids, or other ingredients intended to supplement one's diet. Examples of such supplements include without limit vitamin A, athletic greens powder (ag1), adenine, adenosine triphosphate, alanine, aspartic acid, vitamin B₃, vitamin B₆, vitamin B₁₂, Bifidobacterium breve, Bifidobacterium longum, biotin, bovine peptide, BPC-157, vitamin C, calcium (calcium carbonate), chromium, choline, collagen peptides powder, creatine, copper, cystine, vitamin D, DMAE bitartrate powder, deoxyadenosine, deoxycytidine, vitamin E, fish oil powder, folate, GHRP-6, glucosamine chondroitin, glutamic acid, glutamine, glycine, guarana, histidine, 111hydroxy metabolite, IGF iodine, ipamorelin, iron, isoleucine, jujube fruit, K2 MK-7 powder, kratom powder, Lactobacillus plantarum, leucine, lutein powder, lysine, magnesium, manganese methionine, 5-MeO-DMT, methylfolate, methylene blue molybdenum, NAD powder, niacin pantothenic acid, Pediococcus acidilactici, phenylalanine, phenylethylamine HCl (pea) powder, potassium, prebiotic xylo-oligosaccharides, probiotic blend Bacillus coagulans, proline, quercetin, riboflavin, selenium, serin, sodium, taurine, THC powder, thiamin, threonine, thymidine, thymosin, tryptophan, tyrosine, uridine, valine, wheat grass powder, zeaxanthin powder, and zinc powder.

The term “probiotic powder” represents foods or supplements that contain live microorganisms intended to maintain or improve the “good” bacteria (normal microflora) in the body. Illustrative examples include Bifidobacteria, Lactobacillus acidophilus, Saccharomyces boulardii, Lactobacillus, Bifidobacterium longum, soy milk, buttermilk, and kefir.

The term “protein component” refers to molecules made of amino acids. The term “protein powder” represents proteins that are in a powdered form.

The term “protein powder supplement” as used herein, is synonymous with the term protein component.

The term “semi solid” refers to a category of food products that have properties and consistency between a solid and liquid, such as desserts, sauces, soft fruits, meat, bakery products, ice-cream, melted cheese, and the like.

The term “substantial amount” means an amount that is less than about 90% but more than about 25% by weight of the total mixture. A preferred range for an ingredient present in a substantial amount is from about 55% to about 80%, and a particularly preferred range is from about 60% to about 70% by weight of the mixture.

The term “sugar substitutes” represents artificial sweeteners as defined above.

The term “thickening agent” represents an agent or thickener is a substance which can increase the viscosity of a liquid without substantially changing its other properties. Illustrative examples of thickening agents are guar gum, tapioca, pectin, xanthan gum, cornstarch, arrowroot, and carrageenan.

The term “vitamin” represents a group of organic compounds which are essential for normal growth and nutrition and are required in small quantities in the diet because they cannot be synthesized by the body. They are needed for normal cell function, growth, and development. There are 13 essential vitamins that are required for the body to work properly. They are: vitamin A, vitamin C, vitamin D, vitamin E, vitamin K, vitamin B₁ (thiamine), vitamin B₂ (riboflavin), vitamin B₃ (niacin), vitamin B₆ (pyridoxine), vitamin B₁₂ (cyanocobalamin), pantothenic acid (Bs), biotin (B₇), and folate (folic acid or B₉).

The term “whipped topping” represents ‘fat foams’; upon whipping some fat is released from the fat globules. This fat ‘glues’ a network of fat globules. Air is entrapped in this network thus creating the foam.

The term plant-based whipped topping refers to a whipped topping that is made from plant (vegetable) oils such as, without limitation, coconut oil, palm oil and palm kernel oil. These saturated fats are solid at room temperature and are recognized for their stability. In use, plant-based oils can be used alone or blended and made into a powdered form that has a shelf life of at least two years. These powdered toppings can be reconstituted into an aqueous form by the addition of water with the product then “whipped” or aerated into a form such as whipped cream.

As used herein, the term “whipped” refers to a process by which a liquid is beaten or aerated, by hand or mechanically so as to increase the air content of the product.

Traditional ice creams rely on milk fat to make their texture smooth and creamy, with excellent mouthfeel. However, they have little protein or vitamins or supplements and making them at home can be tedious, messy and require expensive ingredients and appliances to make them. Disclosed herein, are confections made from a powdered mix and reconstituted with water alone. Such confections, frozen, chilled or room temperature have no dairy (no detectable lactose), excellent mouth feel and a low glycemic index. Further, as disclosed, the confections can be made with a powdered mix that has a shelf life of up to two years and which requires only water to reconstitute them.

In one exemplary embodiment, the confections disclosed comprise a plant-based whipped topping, a plant-based protein powder, a plant-based sugar substitute, a flavoring, emulsifiers and salt and are reconstituted with water alone. It should be appreciated that in confections using plant-based whipped toppings, the mixture can be whipped lightly to vigorously, resulting in lesser or greater amount of air incorporated into it. The thickness of the confection is dependent on the amount of water added and the vigor with which it is whipped. Further, those of skill should appreciate that at room temperature or chilled the confection is a spread, mousse or pudding while when frozen the confection has the taste and consistency of an ice cream or popsicle. In these embodiments, it should be appreciated that no dairy is added. Thus, the mixture has no added egg, lactose or other products besides any residual component from the isolated whey protein and should not elicit any dairy allergies.

Plant-based whipped toppings are known to those of skill in the art. For example, plant-based whipped toppings are available at many commercial sources and on-line retailers. These toppings are marketed as dairy-free despite containing milk solids because the product is a blend of ingredients, not just dairy, and is intended as a non-dairy alternative for those who may have mild lactose sensitivities or need a substitute for certain culinary purposes. The presence of milk solids in a non-dairy product can be misleading; however, the product is formulated with vegetable fats, and glucose syrup solids to create a whipped cream alternative that can be used in place of dairy-based creams for specific uses. The term “dairy-free” in the context of such toppings refers to the overall product's composition as a non-dairy alternative. While milk solids are in the ingredient list, this can be a source of confusion. Non-dairy products sometimes contain milk-derived ingredients but are formulated to be dairy-free in the context of the overall product.

### Plant-Based Sugar Alternatives

The U.S. Food and Drug Administration (FDA) has accepted a petition for generally recognized as safe (GRAS) for plant-based sugar alternatives such as allulose as a sugar substitute in various specified food categories. Because it is absorbed and metabolized differently from other sugars, the FDA has exempted allulose from the listing of total and added sugars on the Nutrition and Supplement Facts labels, but requires its weight listing as a carbohydrate, with 0.4 kcal/g (about 1/10 the calories of ordinary carbohydrates).

Studies have shown that products like allulose are not absorbed in the human body the way common sugars are, and it does not raise insulin levels. In 2020, the U.S. FDA accepted the conclusion by Samyang that the maximum tolerable consumption for a 60 kg adult was 33 to 36 grams per day. In healthy humans, insulin secretion begins at relatively low blood glucose levels, roughly 80-120 mg/dL (4.4-6.6 mM), while individuals with pre-diabetes or diabetes may have a lower tolerance for glucose, sometimes experiencing issues with as little as 50 g of carbohydrate at a time. As disclosed herein, a single serving size of the disclosed confection has only about approximately half that amount with zero sugar.

### Glycemic Index

The glycemic index (GI) is a measure of how quickly a carbohydrate-containing food raises blood sugar levels compared to pure glucose (sugar). To calculate the GI, test subjects consume a standard amount of food and then have their blood sugar levels monitored over time. The results are compared to the blood sugar response after consuming pure glucose, which is assigned a GI of 100. In this context, it should be appreciated that the disclosed confections have a low glycemic index with little effect on insulin response.

In various exemplary embodiments the caloric content of the confection comprises 10-75% fat, 25-80% carbohydrate and 5-40% protein. In various exemplary embodiments the plant-based sugar substitute comprises from 20-60% of the caloric content. In various embodiments the sugar substitute comprises from 30-70% of the total carbohydrate component.

A preferred embodiment of this aspect provides a mixture wherein the mixture is configured as a dessert. A further preferred embodiment provides a mixture wherein the fat component is present in a range of from about 10% to about 75% by weight of the mixture.

Another preferred embodiment provides a mixture wherein the fat component comprises a powdered whipped topping. Yet another preferred embodiment provides a mixture wherein the protein component is present in a range of from about 5% to about 40% by weight of the mixture. A further preferred embodiment of this aspect of the invention provides a mixture wherein the protein component comprises a protein powder supplement. A further preferred embodiment provides a mixture wherein the protein component contributes to the structure and stability of the mixture and further provides nutritional benefits.

Another preferred aspect of the present invention provides a mixture wherein the sweetener is present in a range of from about 5% to about 40% by weight of the mixture. A further preferred embodiment of this aspect of the invention provides a mixture wherein the sweetener is selected from the group consisting of low-calorie sweeteners, artificial sweeteners, sugar, powdered sugar, sugar substitutes, and mixtures thereof.

Another preferred as embodiment provides a mixture comprising a thickening agent. A further preferred aspect provides a mixture wherein the thickening agent comprises guar gum. Yet another aspect of the present invention provides a mixture comprising an emulsifying agent. A further preferred embodiment of this aspect provides a mixture wherein the emulsifying agent comprises gum arabic.

Another aspect of the present invention provides a mixture further comprising a flavoring agent. A further preferred embodiment of this aspect provides a mixture wherein the flavoring agents optionally include powdered vanilla, cocoa powder, powdered peanut butter, powdered strawberry, powdered blueberry, powdered banana, powdered peach, powdered pineapple, powdered orange, powdered lemon, powdered caramel, powdered pistachio, powdered coconut, powdered coffee, powdered cinnamon, powdered mint, powdered matcha, powdered mint, powdered mocha, powdered mango, powdered kiwi, powdered watermelon, powdered taro, black truffle, white truffle and mixtures thereof.

Yet another aspect of the present invention provides mixture further comprising a seasoning agent. A further preferred aspect of this embodiment provides a mixture wherein the seasoning agent comprises sodium salt or a sodium salt substitute, or a mixture thereof. Yet another aspect of the present invention provides a mixture further comprising an electrolyte and hydration/hydrating agent. A preferred aspect of this embodiment provides a mixture wherein the electrolyte and hydration agent comprises potassium citrate powder, magnesium, aminos blend, or a mixture thereof.

Another preferred embodiment provides a mixture further comprising a vitamin. A further preferred aspect of this embodiment provides a mixture wherein the vitamin is vitamin C. Yet another preferred aspect of the present invention provides a mixture comprising a wellness and immunity agent. A preferred aspect of this embodiment provides a mixture wherein the wellness and immunity agent is selected from the group consisting of magnesium citrate powder, zinc gluconate powder, collagen+probiotic powder, and a mixture thereof.

Provided in another preferred aspect is a mixture wherein the mixture is in a powdered form that can be reconstituted into a food product. Yet another preferred aspect provides a mixture wherein the mixture is a frozen confection or a frozen aerated confection. A further preferred aspect provides a mixture wherein the mixture is a frozen beverage or a shake.

Another aspect of the present invention provides dessert mixture comprising a substantial amount of a fat component, a moderate amount of a protein component, a minor amount of at least one sweetener, and a minor amount of a flavoring agent, wherein the mixture can be configured in a solid form, a powdered form, a frozen confection, a semisolid or a frozen beverage.

A preferred embodiment of this aspect provides a dessert mixture wherein the dessert mixture is configured as a dessert. A further preferred embodiment provides a dessert mixture wherein the fat component is present in a range of from about 10% to about 75% by weight of the dessert mixture.

Another preferred embodiment provides a dessert mixture wherein the fat component comprises a powdered whipped topping. Yet another preferred embodiment provides a dessert mixture wherein the protein component is present in a range of from about 5% to about 40% by weight of the dessert mixture. A further preferred embodiment of this aspect of the invention provides a dessert mixture wherein the protein component comprises a protein powder supplement. A further preferred embodiment provides a dessert mixture wherein the protein component contributes to the structure and stability of the dessert mixture and further provides nutritional benefits.

The present invention in another embodiment provides a mixture wherein the fat component is present in the range of from about 15% to about 65% of the caloric component, the protein component is present in the range of from about 10% to about 40% of the caloric component, the sweetener is a sugar or a sugar substitute and is present in the range of from about 5% to about 40% of the caloric component, the flavoring agent is present in the range of from about 2% to about 40%, the thickening agent is present in the range of from about 0.5 to about 5%, the emulsifying agent is present in the range of from about 0.5% to about 5%, the electrolyte is present in the range from about 0.5% to about 5%, the wellness agent is present in the range of from about 5% to about 15%, and the seasoning agent is present in the range of from about 0.25 to about 2%

Another preferred aspect of the present invention provides a dessert mixture wherein the sweetener is present in a range of from about 5% to about 40% by weight of the dessert mixture. A further preferred embodiment of this aspect of the invention provides a dessert mixture wherein the sweetener is selected from the group consisting of low-calorie sweeteners, artificial sweeteners, sugar, powdered sugar, sugar substitutes, and mixtures thereof.

Another preferred embodiment provides a dessert mixture comprising a thickening agent. A further preferred aspect provides a dessert mixture wherein the thickening agent comprises guar gum. Yet another aspect of the present invention provides a dessert mixture comprising an emulsifying agent. A further preferred embodiment of this aspect provides a dessert mixture wherein the emulsifying agent comprises gum arabic.

Another aspect of the present invention provides a dessert mixture further comprising a flavoring agent. A further preferred embodiment of this aspect provides a dessert mixture wherein the flavoring agent is selected from the group consisting of powdered vanilla, cocoa powder, powdered peanut butter, powdered strawberry, powdered blueberry, powdered banana, powdered peach, powdered pineapple, powdered orange, powdered lemon, powdered caramel, powdered pistachio, powdered coconut, powdered coffee, powdered cinnamon, powdered mint, powdered matcha, powdered mint, powdered mocha, powdered mango, powdered kiwi, powdered watermelon, powdered taro, black truffle, white truffle and mixtures thereof.

Yet another aspect of the present invention provides dessert mixture further comprising a seasoning agent. A further preferred aspect of this embodiment provides a dessert mixture wherein the seasoning agent comprises sodium salt or a sodium salt substitute, or a mixture thereof. Yet another aspect of the present invention provides a dessert mixture further comprising an electrolyte and hydration/hydrating agent. A preferred aspect of this embodiment provides a dessert mixture wherein the electrolyte and hydration agent comprise potassium citrate powder, magnesium, amino blends, or a mixture thereof.

The present invention in another aspect provides a dessert mixture wherein the fat component is present in the range of from about 15% to about 65%, the protein component is present in the range of from about 5% to about 40%, the sweetener is a sugar or a sugar substitute and is present in the range of from about 5% to about 40%, the flavoring agent is present in the range of from about 2% to about 40%, the thickening agent is present in the range of from about 0.5 to about 5%, the emulsifying agent is present in the range of from about 0.5% to about 5%, the electrolyte is present in the range from about 0.5% to about 5%, the wellness agent is present in the range of from about 5% to about 15%, and the seasoning agent is present in the range of from about 0.25 to about 2%.

Another preferred embodiment provides a dessert mixture further comprising a vitamin. A further preferred aspect of this embodiment provides a dessert mixture wherein the vitamin is vitamin C. Yet another preferred aspect of the present invention provides a dessert mixture comprising a wellness and immunity agent. A preferred aspect of this embodiment provides a dessert mixture wherein the wellness and immunity agent is selected from the group consisting of magnesium citrate powder, zinc gluconate powder, and collagen probiotic powder, and mixtures thereof.

Provided in another preferred aspect is a dessert mixture wherein the dessert mixture is in a powdered form that can be reconstituted into a food product. Yet another preferred aspect provides a dessert mixture wherein the dessert mixture is a frozen confection. A further preferred aspect provides a dessert mixture wherein the dessert mixture is a frozen beverage or a shake.

The present invention, in another aspect provides a process for preparing a mixture, the process comprising blending a mixture comprising a substantial amount of a fat component, a moderate amount of a protein component, a minor amount of at least one of a sweetener, and a minor amount of a flavoring agent, wherein the mixture can be configured in a homogenous or heterogenous solid form or a powdered.

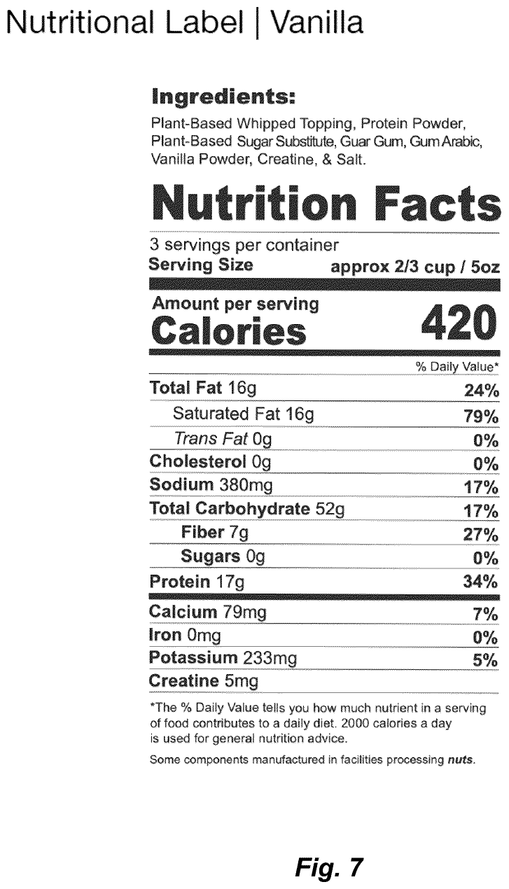

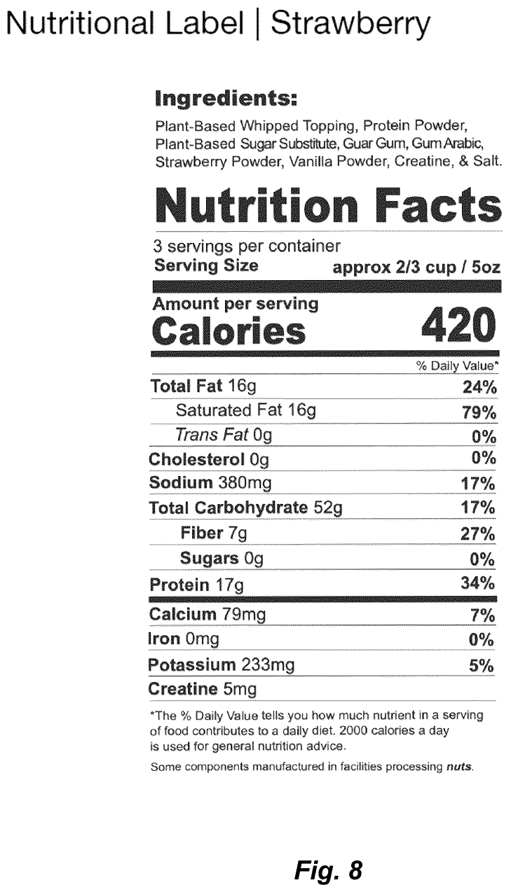

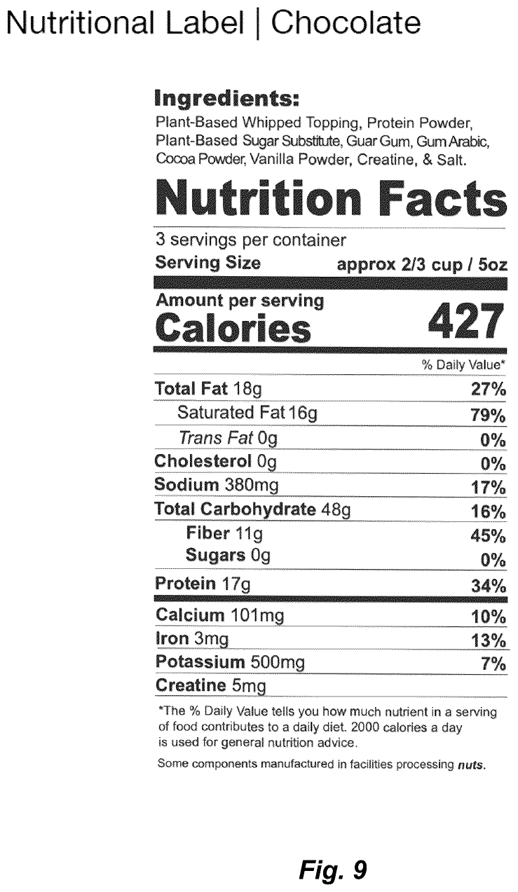

A preferred embodiment of this aspect provides a process wherein the mixture is configured as a dessert, a frozen desert or a frozen aerated dessert. A further preferred embodiment provides a process wherein the fat component is present in a range of from about 15% to about 65% by weight of the mixture and about 15% to 75% of the caloric component of the mixture. Of course, various flavoring agents may be used such as, for example, vanilla (FIG. 7), strawberry (FIG. 8) and chocolate (FIG. 9).

Another preferred embodiment provides a process wherein the fat component comprises a powdered whipped topping. Yet another preferred embodiment provides a process wherein the protein component is present in a range of from about 5% to about 40% by weight of the mixture. A further preferred embodiment of this aspect of the invention provides a process wherein the protein component comprises a protein powder supplement. A further preferred embodiment provides a process wherein the protein component contributes to the structure and stability of the mixture and further provides nutritional benefits.

Another preferred aspect of the present invention provides a process wherein the sweetener is present in a range of from about 5% to about 40% by weight of the mixture and about 20% to about 60% of the caloric content. A further preferred embodiment of this aspect of the invention provides a process wherein the sweetener is selected from the group consisting of low-calorie sweeteners, artificial sweeteners, sugar, powdered sugar, sugar substitutes, and mixtures thereof.

Another preferred embodiment provides a process wherein the fat component is present in the range of from about 15 g % to about 65 g %, the protein component is present in the range of from about 5% to about 40 g %, the sweetener is a sugar or a sugar substitute and is present in the range of from about 5% to about 40 g %, the flavoring agent is present in the range of from about 2 g % to about 40 g %, the thickening agent is present in the range of from about 0.5 g % to about 5 g %, the emulsifying agent is present in the range of from about 0.5 g % to about 5 g %, the electrolyte is present in the range from about 0.5 g % to about 5 g %, the wellness agent is present in the range of from about 5 g % to about 15 g %, and the seasoning agent is present in the range of from about 0.25 g % to about 2 g %.

Another preferred embodiment provides a process comprising a thickening agent. A further preferred aspect provides a process wherein the thickening agent comprises guar gum. Yet another aspect of the present invention provides a process comprising an emulsifying agent. A further preferred embodiment of this aspect provides a process wherein the emulsifying agent comprises gum arabic.

Another aspect of the present invention provides a process further comprising a flavoring agent. A further preferred embodiment of this aspect provides a process wherein the flavoring agent is selected from the group consisting of powdered vanilla, cocoa powder, powdered peanut butter, powdered strawberry, powdered blueberry, powdered banana, powdered peach, powdered pineapple, powdered orange, powdered lemon, powdered caramel, powdered pistachio, powdered coconut, powdered coffee, powdered cinnamon, powdered mint, powdered matcha, powdered mint, powdered mocha, powdered mango, powdered kiwi, powdered watermelon, powdered taro, black truffle, white truffle and a mixture thereof.

Yet another aspect of the present invention provides process further comprising a seasoning agent. A further preferred aspect of this embodiment provides a process wherein the seasoning agent comprises sodium salt or a sodium salt substitute, or a mixture thereof. Yet another aspect of the present invention provides a process further comprising an electrolyte and hydration/hydrating agent. A preferred aspect of this embodiment provides a process wherein the electrolyte and hydration agent comprises potassium citrate powder, magnesium, aminos blend, or a mixture thereof.

Another preferred embodiment provides a process further comprising a vitamin. A further preferred aspect of this embodiment provides a process wherein the vitamin is vitamin C. Yet another preferred aspect of the present invention provides a process comprising a wellness and immunity agent. A preferred aspect of this embodiment provides a process wherein the wellness and immunity agent is selected from the group consisting of magnesium citrate powder, zinc gluconate powder, and collagen probiotic powder and a mixture thereof.

Provided in another preferred aspect is a process wherein the mixture is in a powdered form that can be reconstituted into a food product. Yet another preferred aspect provides a process wherein the mixture is a dessert. Yet another preferred embodiment provides a process wherein the mixture is a frozen confection. A further preferred aspect provides a process wherein the mixture is a frozen beverage or a shake.

Provided in another embodiment is a kit comprising the mixture of any one of the aspects of the present invention or the dessert mixture of any of the aspects of the present invention.

Yet another embodiment provides a kit comprising a first packaging unit comprising a second packaging unit and optionally, instructions for preparing the dessert mixture, and a second packaging unit comprising the mixture or any one of the aspects of the present invention or the dessert mixture of any of the aspects of the present invention.

Those of skill in the art will appreciate that any of the products disclosed herein can be customized by the consumer to contain the supplements and product type desired. In these embodiments, the customer can review a custom blend supplement table (Table 1) and request any blend desired in any form made possible in this disclosure. For example, fitness enthusiasts may wish to order a powder mix supplemented with any supplement recited in Table 1 or other supplement requested in any range from about 5 mcg to about 500 g.

TABLE 1
Custom Blend Supplements

| | | | | FDA | |
|---|---|---|---|---|---|
| | | Recommended | | Daily | |
| # | Description | Daily Amount | | Value | Range per Pint |
| 1 | Vitamin A (as beta-carotene) | 900 | mcg | 100% | 100 mcg to 3500 mcg |
| 2 | Athletic Greens Powder | 12 | g | ** | 5 g to 60 g |
| 3 | Adenine | NA | | ** | 1 g to 15 g |
| 4 | Adenosine Triphosphate | 0.5 | g | ** | 0.5 g to 5 g |
| 5 | Alanine | 6 | g | ** | 3 g to 30 g |
| 6 | Arginine | 7 | g | ** | 3 g to 30 g |
| 7 | Aspartic Acid | 5 | g | ** | 2.5 g to 30 g |
| 8 | Vitamin B₃ (as Pyridoxine | 2 | mg | 118% | 0.5 mg to 15 mg |
| | Hydrochloride) | | | | |
| 9 | Vitamin B6 (as from culture of S. | 1.7 | mg | 100% | 0.5 mg to 10 mg |
| | cerevisiae) | | | | |
| 10 | Vitamin B₁₂ (as cyanocobalamin) | 250 | mcg | 10417% | 100 mcg to 1000 mcg |
| 11 | Bifidobacterium breve | 40 | mg | ** | 20 mg to 200 mg |
| 12 | Bifidobacterium longum | 40 | mg | ** | 20 mg to 200 mg |
| 13 | Biotin | 30 | mcg | ** | 15 mcg to 130 mcg |
| 14 | Bovine Peptide | 15 | g | ** | 5 g to 60 g |
| 15 | BPC 157 | 500 | mg | 100% | 250 mg to 2000 mg |
| 16 | Vitamin C (from Organic Amla Berry) | 90 | mg | 100% | 25 mg to 400 mg |
| 17 | Calcium (Calcium Carbonate) | 1 | g | 100% | .5 g to 5 g |
| 18 | Chromium (as Chromium Chloride) | 35 | mcg | 100% | 15 mcg to 130 mcg |
| 19 | Choline (as Choline Bitartrate) | 550 | mg | 100% | 250 mg to 2000 mg |
| 20 | Collagen Peptides Powder | 11 | g | ** | 5 g to 60 g % |
| 21 | Creatine Monohydrate | 5 | g | ** | 1 g to 30 g |
| 22 | Copper (Cupric Sulfate) | 1 | mg | 125% | 0.5 mg to 7 mg |
| 23 | Cystine | 1.5 | g | ** | 0.5 g to 8 g |
| 24 | Vitamin D (as D₃ from culture of S. | 40 | mcg | 200% | 20 mcg to 300 mcg |
| | cerevisiae) | | | | |
| 25 | DMAE Bitartrate Powder | 350 | mg | ** | 150 mg to 1000 mg |
| 26 | 2′-Deoxyadenosine | NA | | ** | 1 g to 15 g |
| 27 | 2′-Deoxycytidine | NA | | ** | 1 g to 15 g |
| 28 | Vitamin E (as d-alpha tocopherol from | 15 | mg | 100% | 5 mg to 60 mg |
| | Sunflower Oil) | | | | |
| 29 | Fish Oil Powder | 2 | g | 100% | 1 g to 15 g |
| 30 | Folate | 400 | mcg | 100% | 200 mcg to 2500 mcg |
| 31 | GHRP-6 | 5 | g | ** | 1 g to 20 g |
| 32 | Glucosamine Chondroitin | 3 | g | 100% | 1 g to 18 g |
| 33 | Glutamic Acid | 10 | g | ** | 5 g to 50 g |
| 34 | Glutamine | 5 | g | 100% | 1 g to 25 g |
| 35 | Glycine | 15 | g | ** | 7 g to 60 g |
| 36 | Guarana | 800 | mg | ** | 400 mg to 3500 mg |
| 37 | Histidine | 1 | g | *8 | 0.5 g to 5 g |
| 38 | 11-Hydroxy Metabolite | TBD | | ** | TBD |
| 39 | IGF-1 | 5 | g | ** | 1 g to 20 g |
| 40 | Iodine (Potassium Iodine) | 150 | mcg | 100% | 75 mcg to 700 mcg |
| 41 | Ipamorelin | 100 | mcg | 100% | 50 mcg to 400 mcg |
| 42 | Iron (Ferrous Fumarate) | 18 | mg | 100% | 7 mg to 100 mg |
| 43 | Isoleucine | 2 | g | ** | 1 g to 15 g % |
| 44 | Jujube Fruit | 1 | g | 100% | 0.5 g to 5 g |
| 45 | K2 MK-7 Powder (as K1 from culture | 12 | mg | 100% | 5 mg to 60 mg |
| | of S. cerevisiae) | | | | |
| 46 | Kratom Powder | 2 | g | ** | 0.75 g to 15 g |
| 47 | Lactobacillus plantarum | 20 | mg | ** | 10 mg to 100 mg |
| 48 | Leucine | 2.7 | g | ** | 1 g to 15 g % |
| 49 | Lutein Powder | 30 | mg | ** | 15 mg to 125 mg |
| 50 | Lysine | 5 | g | 100% | 2.5 g to 25 g |
| 51 | Magnesium | 425 | mg | 100% | 200 mg to 3000 mg |
| 52 | Manganese (as Manganese Sulfate) | 2.3 | mg | ** | 1 mg to 20 mg |
| 53 | Methionine | 400 | mg | ** | 200 mg to 2000 mg |
| 54 | 5-MeO-DMT | TBD | | ** | TBD |
| 55 | Methylfolate | 10 | g | ** | 5 g to 50 g |
| 56 | Methylene Blue | 2 | g | ** | 1 g to 12 g |
| 57 | Molybdenum (as Sodium Molybdate) | 45 | mcg | 100% | 20 mcg to 300 mcg |
| 58 | NAD Powder | 250 | mg | ** | 100 mg to 1000 mg |
| 59 | Niacin | 20 | mg | 125% | 10 mg to 100 mg |
| 60 | Pantothenic Acid (d-Calcium | 5 | mg | 100% | 2.5 mg to 30 mg |
| | Pantothenate) | | | | |
| 61 | Pediocossus acidilactici | 1 | g | ** | 0.5 g to 4 g |
| 62 | Phenylalanine | 2.5 | g | ** | 1 g to 15 g |
| 63 | Phenylethylamine HCL (PEA) Powder | 150 | mg | ** | 50 mg to 600 mg |
| 64 | Potassium | 4.7 | g | 100% | 2 g to 30 g |
| 65 | Prebiotic Xylo-Oligosaccharides | 10 | g | ** | 5 g to 50 g |
| 66 | Probiotic Blend Bacillus Coagulans | 20 | mg | ** | 10 mg to 100 mg |
| 67 | Proline | 16 | g | ** | 5 g to 50 g |
| 68 | Quercetin | 1 | g | ** | 0.5 g to 5 g |
| 69 | Riboflavin (B2 from culture of S. | 1.3 | mg | 100% | 0.5 mg to 10 mg |
| | cerevisiae) | | | | |
| 70 | Selenium (as Sodium Selenate) | 55 | mcg | 100% | 25 mcg to 300 mcg |
| 71 | Serine | 15 | g | ** | 5 g to 60 g |
| 72 | Sodium (Citrate, Bicarbonate, Chloride) | 1.5 | g | 100% | 0.5 g to 10 g |
| 73 | Taurine | 2 | g | ** | 1 g to 10 g |
| 74 | TB500 | 500 | mg | ** | 250 mg to 2000 mg |
| 75 | THC Powder | 2.5 | mg | ** | 2.5 mg to 30 mg |
| 76 | Thiamin (B1 from culture of S. | 1.2 | mg | 100% | 0.5 mg to 10 mg |
| | cerevisiae) | | | | |
| 77 | Threonine | 1.2 | g | ** | 1 g to 10 g |
| 78 | Thymidine | NA | | ** | 1 g to 15 g |
| 79 | Thymosin | 5 | mg | ** | 2.5 mg to 30 mg |
| 80 | Tryptophan | 478 | mg | ** | 200 mg to 2000 mg |
| 81 | Tyrosine | 1148 | mg | ** | 500 mg to 4000 mg |
| 82 | Urban Ice Organics | 1000 | mg | ** | 500 mg to 5000 mg |
| 83 | Uridine | 1 | g | ** | 0.5 g to 5 g |
| 84 | Valine | 3 | g | ** | 1 g to 25 g |
| 85 | Wheat Grass Powder | 1.5 | g | ** | 0.5 g to 8 g |
| 86 | Zeaxanthan Powder | 100 | mg | ** | 50 mg to 500 mg |
| 87 | Zinc Powder | 11 | mg | 100% | 5 mg to 50 mg |
| 88 | LipoNad | 250 | g | | 100-500 g |

** The FDA has not established a recommended Daily Value

### Process A: Frozen Treat 4 (Soft Serve)

A frozen treat, such as a soft serve ice cream, can be prepared as follows. In a large 5-gallon bucket is added four (4) quarts of cold water. To the cold water is then added about four (4) pounds (lbs.) of the powdered mixture to yield a wet mixture. To the wet mixture is then added an additional three (3) quarts of cold water and the resulting mixture is agitated to yield a homogenous mixture. The homogenous mixture is then added to a commercial grade soft serve machine (which can be purchased from many commercial sources and on-line retailers) and subjected to the process as per the instructions of the respective machine to yield a soft serve version of the frozen treat.

Process B: Custom Blend Fitness and Health food Products

The invention provides a base ingredient recipe, and a premium ingredient recipes (see the Examples below), to which one or more custom supplements selected from Table 1, or other supplement available for incorporation by customer/end user, are added.

The present invention is further illustrated and supported by the following examples. However, these examples should in no way be considered to further limit the scope of the invention. To the contrary, one having ordinary skill in the art would readily understand that there are other embodiments, modifications, and equivalents of the present invention without departing from the spirit of the present invention and/or the scope of the appended claims.

### EXAMPLES

### Process I: Making the Mixture

In a large mixing bowl, different ingredients listed in the Examples below were combined at room temperature and in a dry powder form. The different ingredients were mixed thoroughly by hand using a hand mixture or a spatula to yield the mixtures, in the form of a dry powder, with different properties and flavors. Of course, those of skill in the art will appreciate that commercial mixers can be used for making large quantities of powdered mixtures.

### Process II: Making Frozen Treats

In a mixing bowl combine the dry powder/mixture from Process I with water. The ratio of the dry mixture to water was 1:0.75 by volume, i.e. for every two cups/unit, by volume, of the dry mixture there was three-quarters (¾) cup/unit of water by volume. The resulting mixture was whisked for about 60 to 200 seconds, or until it thickened. This whisked thickened mixture was then transferred to a food and freezer safe container and placed in a freezer at temperatures of from about −10° C. to about 10° C. for about 2 to about 4 hours yielding a confection in the form of an ice cream.

### Process III: Frozen Treat 2

In a mixing bowl combine the dry powder/mixture from Process I with water. The ratio of the dry mixture to water was 1:0.75 by volume, i.e., for every two cups/unit, by volume, of the dry mixture there was three-quarters (¾) cup/unit of water by volume. The resulting mixture was agitated using a food processor, blender, or hand mixer device. The mixing device was used wherein the mixture was pulsed to form a thick homogenous mixture. This processed thickened mixture was then transferred to a food and freezer safe container and placed in a freezer at temperatures of from about −10° C. to about 10° C. for about 2 to about 4 hours yielding a confection in the form of an ice cream. It should be noted that to obtain freezing the above mixture from processes II and III for about four (4) hours or more, yielded the frozen treat as a firm solid ice-cream. Freezing the mixture from Processes II and III respectively, for less than four (4) hours yielded frozen treats with different consistencies, i.e., consistency like a yogurt, softer ice cream, or even a slushy consistency.

It should be noted that to obtain freezing the above mixture from processes II and III for about four (4) hours or more, yielded the frozen treat as a firm solid ice-cream. Freezing the mixture from Processes II and III respectively, for less than four (4) hours yielded frozen treats with different consistencies, i.e. consistency like a yogurt, softer ice cream, or even a slushy consistency.

### Example 1: Base Vanilla Ice Cream Powder

Powdered Whipped Topping (50 to 400 grams)
Protein Powder (25 to 200 grams)
Sugar Substitute (25 to 200 grams)
Guar Gum (1 to 15 grams)
Gum Arabic (1 to 15 grams)
Powdered Vanilla (20 to 150 grams)
Salt (0.15 to 1 grams)

### Example 2: Premium Vanilla Ice Cream Powder

Powdered Whipped Topping (50 to 400 grams)
Protein Powder (25 to 200 grams)
Sugar Substitute (25 to 200 grams)
Creatine Powder (5 to 45 grams)
Collagen Powder (10 to 90 grams)
Powder (5 to 45 grams)
Vitamin C Powder (2 to 8 grams)
Potassium Powder (1 to 8 grams)
Magnesium Powder (10 to 24 grams)
Zinc Powder (1 to 8 grams)
Gum Arabic (1 to 15 grams)
Guar Gum (1 to 15 grams)
Powdered Vanilla (20 to 150 grams)
Salt (0.15 to 1 gram)

### Example 3: Base Chocolate Ice Cream Powder

Powdered Whipped Topping (50 to 400 grams)
Protein Powder (25 to 200 grams)
Sugar Substitute (25 to 200 grams)
Guar Gum (1 to 15 grams)
Gum Arabic (1 to 15 grams)
Cocoa Powder (25 to 150 grams)
Powdered Vanilla (15 to 150 grams)
Salt (0.15 to 1 gram)

### Example 4: Premium Chocolate Ice Cream Powder

Powdered Whipped Topping (50 to 400 grams)
Protein Powder (25 to 200 grams)
Sugar Substitute (25 to 200 grams)
Creatine Powder (5 to 45 grams)
Collagen Powder (10 to 90 grams)
Vitamin C Powder (2 to 8 grams)
Potassium Powder (1 to 8 grams)
Magnesium Powder (10 to 24 grams)
Zinc Powder (1 to 8 grams)
Guar Gum (1 to 15 grams)
Gum Arabic (1 to 15 grams)
Cocoa Powder (25 to 150 grams)
Powdered Vanilla (15 to 150 grams)
Salt (0.15 to 1 gram)

### Example 5: Base Strawberry Ice Cream Powder

Powdered Whipped Topping (50 to 400 grams)
Protein Powder (25 to 200 grams)
Sugar Substitute (25 to 100 grams)
Guar Gum (1 to 15 grams)
Gum Arabic (1 to 15 grams)
Strawberry Flavoring Powder (20 to 100 grams)
Powdered Vanilla (20 to 100 grams)
Salt (0.15 to 1 gram)

### Example 6: Premium Strawberry Ice Cream Powder

Powdered Whipped Topping (50 to 400 grams)
Protein Powder (25 to 200 grams)
Sugar Substitute (25 to 200 grams)
Creatine Powder (5 to 45 grams)
Collagen Powder (10 to 90 grams)
Vitamin C Powder (2 to 8 grams)
Potassium Powder (1 to 8 grams)
Magnesium Powder (10 to 24 grams)
Zinc Powder (1 to 8 grams)
Guar Gum (1 to 15 grams)
Gum Arabic (1 to 15 grams)
Strawberry Flavoring Powder (20 to 100 grams)
Powdered Vanilla (20 to 100 grams)
Salt (0.15 to 1 gram)

### Example 7: Base Blueberry Ice Cream Powder

Powdered Whipped Topping (100 to 400 grams)
Protein Powder (25 to 200 grams)
Sugar Substitute (25 to 100 grams)
Guar Gum (1 to 15 grams)
Gum Arabic (1 to 15 grams)
Blueberry Flavoring Powder (20 to 100 grams)
Powdered Vanilla (20 to 100 grams)
Salt (0.15 to 1 grams)

### Example 8: Premium Blueberry Ice Cream Powder

Powdered Whipped Topping (100 to 400 grams);
Protein Powder (25 to 200 grams)
Sugar Substitute (25 to 200 grams)
Creatine Powder (5 to 45 grams)
Collagen Powder (10 to 90 grams)
Vitamin C Powder (2 to 8 grams)
Potassium Powder (1 to 8 grams)
Magnesium Powder (10 to 24 grams)
Zinc Powder (1 to 8 grams)
Guar Gum (1 to 15 grams)
Gum Arabic (1 to 15 grams)
Blueberry Flavoring Powder (20 to 100 grams)
Powdered Vanilla (20 to 100 grams)
Salt (0.15 to 1 grams)

### Example 9: Base Chocolate Mint Ice Cream Powder

Powdered Whipped Topping (50 to 400 grams);
Protein Powder (25 to 200 grams);
Sugar Substitute (25 to 200 grams);
Guar Gum (1 to 15 grams);
Gum Arabic (1 to 15 grams);
Cocoa Powder (25 to 150 grams);
Powdered Vanilla (15 to 150 grams);
Peppermint Flavoring Powder (1 to 10 grams);
Salt (0.15 to 1 grams).

### Example 10: Premium Chocolate Mint Ice Cream Powder

Powdered Whipped Topping (50 to 400 grams)
Protein Powder (25 to 200 grams)
Sugar Substitute (25 to 200 grams)
Creatine Powder (5 to 45 grams)
Collagen Powder (10 to 90 grams)
Vitamin C Powder (2 to 8 grams)
Potassium Powder (1 to 8 grams)
Magnesium Powder (10 to 24 grams)
Zinc Powder (1 to 8 grams)
Guar Gum (1 to 15 grams)
Gum Arabic (1 to 15 grams)
Cocoa Powder (25 to 150 grams)
Powdered Vanilla (15 to 150 grams)
Peppermint Flavoring Powder (1 to 10 grams)
Salt (0.15 to 1 grams)

### Example 11: Popsicles

Mixtures of the instant invention can be used to prepare popsicles by the procedure outlined above, followed by freezing the mixture in a desired shape, optionally with a handle (e.g., a stick) and optionally with a packaging.

### Example 12: Strawberry Popsicle Powder

A mixture having strawberry flavor is as follows:
Protein Powder (25 to 200 grams)
Sugar Substitute (25 to 250 grams)
Creatine Powder (5 to 45 grams)
Strawberry Flavoring Powder (10 to 200 grams)
Vitamin C Powder (2 to 18 grams)
Potassium Powder (5 to 30 grams)
Magnesium Powder (1 to 20 grams)
Zinc Powder (0.5 to 8 grams)
Guar Gum (0.5 to 8 grams)
Gum Arabic (0.5 to 8 grams)
Powdered Vanilla (2 to 50 grams)
Salt (0.15 to 5 grams)

### Example 13: Strawberry Sorbet Powder

Sorbets having fruit flavor are exemplified by the strawberry flavor as follows, reconstituted with either water or a fruit juice.
Protein Powder (25 to 200 grams)
Sugar Substitute (25 to 250 grams)
Creatine Powder (5 to 45 grams)
Strawberry Flavoring Powder (10 to 200 grams)
Guar Gum (0.5 to 1 grams)
Gum Arabic (0.5 to 1 grams)
Powdered Vanilla (2 to 150 grams)
Salt (0.15 to 5 grams)

### Example 14: Frozen Smoothies

Mixtures of the instant invention can be prepared by the procedure outlined above. A mixture having strawberry flavor is as follows, reconstituted with either water, juice, milk, or a dairy alternative, process also involves processing the product via a hand or counter top mixer or a blender before freezing to a desired hardness.

### Example 15: Strawberry Frozen Smoothie Powder

Powdered Whipped Topping (25 to 200 grams)
Protein Powder (25 to 200 grams)
Sugar Substitute (25 to 250 grams)
Creatine Powder (5 to 45 grams)
Strawberry Flavoring Powder (10 to 200 grams)
Vitamin C Powder (2 to 18 grams)
Potassium Powder (5 to 30 grams)
Magnesium Powder (1 to 20 grams)
Zinc Powder (0.5 to 8 grams)
Guar Gum (0.5 to 5 grams)
Gum Arabic (0.5 to 5 grams)
Powdered Vanilla (2 to 150 grams)
Salt (0.15 to 5 grams)

### Aspects of the Invention

The following paragraphs enumerated consecutively from 1 through 30 provide various additional aspects of the present invention. In one embodiment is a first paragraph:
1. A powdered mix for making a confection comprising:
   one or more vegetable based powdered whipped topping;
   one or more protein isolate powder;
   one or more plant-based sugar alternative; and
   one or more flavoring;
wherein the powdered mix is dairy free and lactose free; and wherein the fat component is 90-100% saturated fat;
optionally wherein when reconstituted with water or juice the mixture comprises an aqueous mixture.
2. The powdered mix of paragraph 1, wherein the vegetable based powdered whipped topping comprises coconut cream, aquafaba, soy milk, almond milk, coconut oil, or palm oil, palm kernel oil or a combination thereof.
3. The powdered mix of any one of paragraphs 1-2, wherein the protein isolate is whey, soy, pea and combinations thereof.
4. The powdered mix of any one of paragraphs 1-3, wherein the plant-based sugar alternative is selected from stevia, monk fruit, allulose, coconut sugar, maple syrup, agave nectar, honey, erythritol, xylitol, sucralose, and neotame.
5. The powdered mix of any one of paragraphs 1-4, wherein the flavoring is selected from chocolate, vanilla, strawberry, coffee, vanilla, cocoa, peanut butter, strawberry, blueberry, banana, peach, pineapple, orange, lemon, caramel, pistachio, coconut, coffee, cinnamon, mint, powdered matcha, mint, mocha, mango, hazelnut, kiwi, watermelon, taro, black truffle, white truffle and mixtures thereof.
6. The powdered mix of any one of paragraphs 1-5, wherein the powdered mix has a shelf life of two years or more.
7. The powdered mix of any one of paragraphs 1-6, further comprising an emulsifier.
8. The powdered mix of any one of paragraphs 1-7, wherein the emulsifier is selected from guar gum, xanthan gum, lecithin, polysorbates, monoglycerides, diglycerides, cetearyl alcohol, carrageenan, gum Arabic, polysorbate, and combinations thereof.
9. The powdered mix of any one of paragraphs 1-8, further comprising one or more supplements selected from vitamin A, athletic greens powder (ag1), adenine, adenosine triphosphate, alanine, aspartic acid, vitamin B₃, vitamin B₆, vitamin B₁₂, Bifidobacterium breve, Bifidobacterium longum, biotin, bovine peptide, BPC-157, vitamin C, calcium (calcium carbonate), chromium, choline, collagen peptides powder, creatine, copper, cystine, vitamin D, DMAE bitartrate powder, deoxyadenosine, deoxycytidine, vitamin E, fish oil powder, folate, GHRP-6, glucosamine chondroitin, glutamic acid, glutamine, glycine, guarana, histidine, 11-hydroxy metabolite, IGF iodine, ipamorelin, iron, isoleucine, jujube fruit, K2 MK-7 powder, kratom powder, Lactobacillus plantarum, leucine, lutein powder, lysine, magnesium, manganese methionine, 5-MeO-DMT, methylfolate, methylene blue molybdenum, NAD powder, niacin pantothenic acid, Pediococcus acidilactici, phenylalanine, phenylethylamine HCl (pea) powder, potassium, prebiotic xylo-oligosaccharides, probiotic blend Bacillus coagulans, proline, quercetin, riboflavin, selenium, serin, sodium, taurine, THC powder, thiamin, threonine, thymidine, thymosin, tryptophan, tyrosine, uridine, valine, wheat grass powder, zeaxanthin powder, zinc powder and combinations thereof.
10. The powdered mix of any one of paragraphs 1-9, wherein the mix further comprises salt.
11. The powdered mix of any one of paragraphs 1-10, wherein the fat, carbohydrate and protein are present in a g % ratio of about 10% to 75%/25% to 80%/5% to 40% (the three-part ratio of fat, carbohydrate and protein). In various embodiments, the fat content can be about 15%, about 20%, about 25%, about 30%, about 35%, about 40%, about 45%, about 50%, about 55%, about 60%, about 65%, or about 70%, or a range from any one to another of these recited percentages, in the three-part ratio of fat, carbohydrate and protein. In various embodiments, the carbohydrate content can be about 30%, about 35%, about 40%, about 45%, about 50%, about 55%, about 60%, about 65%, about 70%, or about 75%, or a range from any one to another of these recited percentages, in the three-part ratio of fat, carbohydrate and protein. In various embodiments, the protein content can be about 10%, about 15%, about 20%, about 25%, about 30%, or about 35%, or a range from any one to another of these recited percentages, in the three-part ratio of fat, carbohydrate and protein.
12. The powdered mix of any one of paragraphs 1-11, wherein the plant-based sugar alternative comprises 20-60 g % of total carbohydrate component. In various embodiments, the plant-based sugar alternative comprises about 25 g % to about 55 g %, about 30 g % to about 50 g %, about 35 g % to about 45 g %, about 35 g % to about 55 g %, or about 25 g % to about 45 g %, of total carbohydrate component
13. The powdered mix of any one of paragraphs 1-12, wherein the aqueous mixture is room temperature, chilled or frozen.
14. An aqueous confection comprising:
   one or more vegetable based powdered whipped topping;
   one or more protein isolate;
   one or more plant-based sugar alternative;
   one or more flavoring; and
   water or juice;
wherein the aqueous confection is dairy free.
15. The aqueous confection of paragraph 14, wherein the confection is room temperature, chilled or frozen.
16. The aqueous confection of any one of paragraphs 13-14, wherein the plant-based sugar alternative is selected from stevia, monk fruit, allulose, coconut sugar, maple syrup, agave nectar, honey, erythritol, xylitol, sucralose, and neotame.
17. The aqueous confection of any one of paragraphs 13-15, wherein the flavoring is selected from chocolate, vanilla, strawberry, coffee, vanilla, cocoa, peanut butter, strawberry, blueberry, banana, peach, pineapple, orange, lemon, caramel, pistachio, coconut, coffee, cinnamon, mint, powdered matcha, mint, mocha, mango, hazelnut, kiwi, watermelon, taro, black truffle, white truffle and mixtures thereof.
18. The aqueous confection of any one of paragraphs 13-16, wherein the fat, carbohydrate and protein are present in a g % ratio of about 10% to 75%/25% to 80%/5% to 40%.
19. The aqueous confection of any one of paragraphs 13-17, wherein the plant-based sugar alternative comprises 20-60% of total carbohydrate component.
20. The aqueous confection of any of paragraphs 14-19 further comprising one or more supplements selected from vitamin A, athletic greens powder (ag1), adenine, adenosine triphosphate, alanine, aspartic acid, vitamin B₃, vitamin B₆, vitamin B₁₂, Bifidobacterium breve, Bifidobacterium longum, biotin, bovine peptide, BPC-157, vitamin C, calcium (calcium carbonate), chromium, choline, collagen peptides powder, creatine, copper, cystine, vitamin D, DMAE bitartrate powder, deoxyadenosine, deoxycytidine, vitamin E, fish oil powder, folate, GHRP-6, glucosamine chondroitin, glutamic acid, glutamine, glycine, guarana, histidine, 11-hydroxy metabolite, IGF iodine, ipamorelin, iron, isoleucine, jujube fruit, K2 MK-7 powder, kratom powder, Lactobacillus plantarum, leucine, lutein powder, lysine, magnesium, manganese methionine, 5-MeO-DMT, methylfolate, methylene blue, molybdenum, NAD powder, niacin pantothenic acid, Pediococcus acidilactici, phenylalanine, phenylethylamine HCl (pea) powder, potassium, prebiotic xylo-oligosaccharides, probiotic blend Bacillus coagulans, proline, quercetin, riboflavin, selenium, serin, sodium, taurine, THC powder, thiamin, threonine, thymidine, thymosin, tryptophan, tyrosine, uridine, valine, wheat grass powder, zeaxanthin powder, zinc powder and combinations thereof.
21. A method of making a confection comprising:
   (a) combining:
      one or more plant-based powdered whipped topping;
      one or more purified whey protein powder;
      one or more plant-based sugar alternative; and
      one or more flavoring; to form a mixture;
   (b) sifting the mixture through a 30-gauge mesh sieve to create sifted mixture comprising a fine powder; and
   (c) mixing the sifted mixture with water to provide an aqueous mixture;
wherein the confection is dairy free.
22. The method of paragraph 21, wherein the sifted mixture is passed through the 30-gauge mesh a second time.
23. The method of any one of paragraphs 21-22, wherein the aqueous mixture is room temperature, chilled or frozen.
24. The method of any one of paragraphs 21-23, wherein the vegetable based powdered whipped topping is made from coconut cream, aquafaba, soy milk, almond milk, hydrogenated coconut oil, hydrogenated palm oil and combinations thereof.
25. The method of any one of paragraphs 21-24, wherein the protein isolate is whey protein.
26. The method of any one of paragraphs 21-25, wherein the plant-based sugar alternative is selected from stevia, monk fruit, allulose, coconut sugar, maple syrup, agave nectar, honey, erythritol, xylitol, sucralose, and neotame.
27. The method of any one of paragraphs 21-26, wherein the flavoring is selected from chocolate, vanilla, strawberry, coffee, vanilla, cocoa, peanut butter, strawberry, blueberry, banana, peach, pineapple, orange, lemon, caramel, pistachio, coconut, coffee, cinnamon, mint, powdered matcha, mint, mocha, mango, hazelnut, kiwi, watermelon, taro, black truffle, white truffle and mixtures thereof.
28. The method of any of paragraphs 21-27 further comprising one or more supplements selected from vitamin A, athletic greens powder (ag1), adenine, adenosine triphosphate, alanine, aspartic acid, vitamin B₃, vitamin B₆, vitamin B₁₂, Bifidobacterium breve, Bifidobacterium longum, biotin, bovine peptide, bpc, vitamin C, calcium (calcium carbonate), chromium, choline, collagen peptides powder, creatine, copper, cystine, vitamin D, DMAE bitartrate powder, deoxyadenosine, deoxycytidine, vitamin E, fish oil powder, folate, GHRP-6, glucosamine chondroitin, glutamic acid, glutamine, glycine, guarana, histidine, 11-hydroxy metabolite, IGF iodine, ipamorelin, iron, isoleucine, jujube fruit, K2 MK-7 powder, kratom powder, Lactobacillus plantarum, leucine, lutein powder, lysine, magnesium, manganese methionine, 5-MeO-DMT, methylfolate, methylene blue molybdenum, NAD powder, niacin pantothenic acid, Pediococcus acidilactici, phenylalanine, phenylethylamine HCl (pea) powder, potassium, prebiotic xylo-oligosaccharides, probiotic blend Bacillus coagulans, proline, quercetin, riboflavin, selenium, serin, sodium, taurine, THC powder, thiamin, threonine, thymidine, thymosin, tryptophan, tyrosine, uridine, valine, wheat grass powder, zeaxanthin powder, zinc powder and combinations thereof.
29. The aqueous confection of any one of paragraphs 21-28, wherein the fat, carbohydrate and protein are present in a ratio in g/% of about 10-75/25-80/5-40.
30. The aqueous confection of any one of paragraphs 21-29, wherein the plant-based sugar alternative comprises 20-60% of total carbohydrate component.

All publications, patents, and patent documents cited herein are incorporated by reference as though individually incorporated by reference. No limitations inconsistent with this disclosure are to be understood therefrom. The invention has been described with reference to various specific and preferred embodiments and techniques. However, many variations and modifications may be made while remaining within the spirit and scope of the invention.

While specific embodiments have been described above with reference to the disclosed embodiments and examples, such embodiments are only illustrative and do not limit the scope of the invention. Changes and modifications can be made in accordance with ordinary skill in the art without departing from the invention in its broader aspects as defined in the following claims.

What is claimed is:

1. A powdered mix for making a confection comprising:
one or more plant-based powdered whipped topping;
one or more protein isolate powder
one or more plant-based sugar alternative; and
one or more flavoring;
wherein the powdered mix is dairy free and lactose free; the fat component is about 85-100% saturated fat; and optionally wherein when reconstituted with water or juice the mixture comprises an aqueous mixture.

2. The powdered mix of claim 1, wherein the vegetable based powdered whipped topping comprises coconut cream, aquafaba, soy milk, almond milk, coconut oil, or palm oil, palm kernel oil or a combination thereof.

3. The powdered mix of claim 1, wherein the plant-based sugar alternative is selected from stevia, monk fruit, allulose, coconut sugar, maple syrup, agave nectar, honey, erythritol, xylitol, sucralose, and neotame.

4. The powdered mix of claim 1, further comprising an emulsifier.

5. The powdered mix of claim 1, wherein the fat, carbohydrate and protein are present in a g % ratio of about 10% to 75%/25% to 80%/5% to 40%.

6. The powdered mix of claim 1, wherein the plant-based sugar alternative comprises 20-60 g % of total carbohydrate component.

7. The powdered mix of claim 1, further comprising a supplement, wherein the supplement is selected from: supplements include without limit vitamin A, athletic greens powder (ag1), adenine, adenosine triphosphate, alanine, aspartic acid, vitamin B₃, vitamin B₆, vitamin B₁₂, Bifidobacterium breve, Bifidobacterium longum, biotin, bovine peptide, BPC-157, vitamin C, calcium (calcium carbonate), chromium, choline, collagen peptides powder, creatine, copper, cystine, vitamin D, DMAE bitartrate powder, deoxyadenosine, deoxycytidine, vitamin E, fish oil powder, folate, GHRP-6, glucosamine chondroitin, glutamic acid, glutamine, glycine, guarana, histidine, 11-hydroxy metabolite, IGF iodine, ipamorelin, iron, isoleucine, jujube fruit, K2 MK-7 powder, kratom powder, Lactobacillus plantarum, leucine, lutein powder, lysine, magnesium, manganese methionine, 5-MeO-DMT, methylfolate, methylene blue molybdenum, NAD powder, niacin pantothenic acid, Pediococcus acidilactici, phenylalanine, phenylethylamine, potassium, prebiotic xylo-oligosaccharides, probiotic blend Bacillus coagulans, proline, quercetin, riboflavin, selenium, serin, sodium, taurine, THC powder, thiamin, threonine, thymidine, thymosin, tryptophan, tyrosine, uridine, valine, wheat grass powder, zeaxanthan powder, zinc powder, and combinations thereof.

8. An aqueous confection comprising:
one or more vegetable based powdered whipped topping;
one or more protein isolate;
one or more plant-based sugar alternative;
one or more flavoring; and
water or juice;
wherein the aqueous confection is dairy free.

9. The aqueous confection of claim 8, wherein the plant-based sugar alternative is selected from stevia, monk fruit, allulose, coconut sugar, maple syrup, agave nectar, honey, erythritol, xylitol, sucralose, and neotame.

10. The aqueous confection of claim 8, wherein the flavoring is selected from chocolate, vanilla, strawberry, coffee, vanilla, cocoa, peanut butter, strawberry, blueberry, banana, peach, pineapple, orange, lemon, caramel, pistachio, coconut, coffee, cinnamon, mint, powdered matcha, mint, mocha, mango, hazelnut, kiwi, watermelon, taro, black truffle, white truffle and mixtures thereof.

11. The aqueous confection of claim 8, wherein the fat, carbohydrate and protein are present in a g % ratio of about 10% to 75%/25% to 80%/5% to 40%.

12. The aqueous confection of claim 8, wherein the plant-based sugar alternative comprises 20-60% of total carbohydrate component.

13. The aqueous confection of claim 8, further comprising a supplement, wherein the supplement is selected from: supplements include without limit vitamin A, athletic greens powder (ag1), adenine, adenosine triphosphate, alanine, aspartic acid, vitamin B₃, vitamin B₆, vitamin B₁₂, Bifidobacterium breve, Bifidobacterium longum, biotin, bovine peptide, BPC-157, vitamin C, calcium (calcium carbonate), chromium, choline, collagen peptides powder, creatine, copper, cystine, vitamin D, DMAE bitartrate powder, deoxyadenosine, deoxycytidine, vitamin E, fish oil powder, folate, GHRP-6, glucosamine chondroitin, glutamic acid, glutamine, glycine, guarana, histidine, 11 hydroxy metabolite, IGF iodine, ipamorelin, iron, isoleucine, jujube fruit, K2 MK-7 powder, kratom powder, Lactobacillus plantarum, leucine, lutein powder, lysine, magnesium, manganese methionine, 5-MeO-DMT, methylfolate, methylene blue molybdenum, NAD powder, niacin pantothenic acid, Pediococcus acidilactici, phenylalanine, phenylethylamine HCl (pea) powder, potassium, prebiotic xylo-oligosaccharides, probiotic blend Bacillus coagulans, proline, quercetin, riboflavin, selenium, serin, sodium, taurine, THC powder, thiamin, threonine, thymidine, thymosin, tryptophan, tyrosine, uridine, valine, wheat grass powder, zeaxanthin powder, zinc powder and combinations thereof.

14. A method of making a confection comprising:
(a) combining:
one or more vegetable based powdered whipped topping;
one or more purified whey protein powder;
one or more plant-based sugar alternative; and
one or more flavoring; to form a mixture;
(b) sifting the mixture through a 15-50-gauge mesh sieve to create sifted mixture comprising a fine powder; and
(c) mixing the sifted mixture with or juice;
wherein the protein component is present in the range of from about 5% to about 40% to provide an aqueous mixture; and wherein the confection is dairy free.

15. The method of claim 14, wherein the sifted mixture is passed through the mesh sieve a second time.

16. The method of claim 14, wherein the vegetable based powdered whipped topping is made from coconut cream, aquafaba, soy milk, almond milk, coconut oil, palm oil and combinations thereof.

17. The method of claim 14, wherein the plant-based sugar alternative is selected from stevia, monk fruit, allulose, coconut sugar, maple syrup, agave nectar, honey, erythritol, xylitol, sucralose, and neotame.

18. The method of claim 14, wherein the composition of the aqueous confection of fat, carbohydrate and protein are present in a ratio in g/% of about 10-75/20-80/5-40.

19. The method one of claim 14, wherein the plant-based sugar alternative comprises 20-60% of total carbohydrate component.

20. The method of claim 14, further comprising a supplement, wherein the supplement is selected from: supplements include without limit vitamin A, athletic greens powder (ag1), adenine, adenosine triphosphate, alanine, aspartic acid, vitamin B3, vitamin B6, vitamin B12, Bifidobacterium breve, Bifidobacterium longum, biotin, bovine peptide, BPC-157, vitamin C, calcium (calcium carbonate), chromium, choline, collagen peptides powder, creatine, copper, cystine, vitamin D, DMAE bitartrate powder, deoxyadenosine, deoxycytidine, vitamin E, fish oil powder, folate, GHRP-6, glucosamine chondroitin, glutamic acid, glutamine, glycine, guarana, histidine, 11 hydroxy metabolite, IGF iodine, ipamorelin, iron, isoleucine, jujube fruit, K2 MK-7 powder, kratom powder, Lactobacillus plantarum, leucine, lutein powder, lysine, magnesium, manganese methionine, 5-MeO-DMT, methylfolate, methylene blue molybdenum, NAD powder, niacin pantothenic acid, Pediococcus acidilactici, phenylalanine, phenylethylamine HCl (pea) powder, potassium, prebiotic xylo-oligosaccharides, probiotic blend Bacillus coagulans, proline, quercetin, riboflavin, selenium, serin, sodium, taurine, THC powder, thiamin, threonine, thymidine, thymosin, tryptophan, tyrosine, uridine, valine, wheat grass powder, zeaxanthin powder, zinc powder and combinations thereof.
